(19) United States
(12) Patent Application Publication
(10) Pub. No.: US 2024/0104145 A1
(43) Pub. Date: Mar. 28, 2024

(54) USING A GRAPH OF REDIRECTS TO IDENTIFY MULTIPLE ADDRESSES REPRESENTING A COMMON WEB PAGE

(71) Applicant: Oxylabs UAB, Vilnius (LT)

(72) Inventor: Tadas BARZDZIUS, Vilnius (LT)

(73) Assignee: Oxylabs UAB, Vilnius (LT)

(21) Appl. No.: 17/950,962

(22) Filed: Sep. 22, 2022

(51) Int. Cl. G06F 16/951; G06F 16/955; G06F 16/958

(52) U.S. Cl. CPC G06F 16/951; G06F 16/9566; G06F 16/986

(57) ABSTRACT

Embodiments relate to scraping web content. When scraping data, the target website sometimes redirects to different URLs within its domain. The different URLs represent the same context. Embodiments use a graph ontology to identify which redirected URLs represent the same page.

### BACKGROUND

### Field

This field is generally related to web scraping.

### Related Art

Web scraping (also known as screen scraping, data mining, web harvesting) is the automated gathering of data from the Internet. It is the practice of gathering data from the Internet through any means other than a human using a web browser. Web scraping is usually accomplished by executing a program that queries a web server and requests data automatically, then parses the data to extract the requested information.

To conduct web scraping, a program known as a web crawler may be used. A web crawler, sometimes called a web spider, is a program or an automated script which performs the first task, i.e. it navigates the web in an automated manner to retrieve data, such as Hypertext Transfer Markup Language (HTML) data, JSONs, XML, and binary files, of the accessed websites.

Web scraping is useful for a variety of applications. In a first example, web scraping may be used for search engine optimization. Search engine optimization (SEO) is the process of improving the quality and quantity of website traffic to a website or a web page from search engines. A web search engine, such as the Google search engine available from Google Inc. of Mountain View, California, has a particular way of ranking its results, including those that are unpaid. To raise the location of a website in search results, SEO may, for example, involve cross-linking between pages, adjusting the content of the website to include a particular keyword phrase, or updating content of the website more frequently. An automated SEO process may need to scrape search results from a search engine to determine how a website is ranked among search results.

In a second example, web scraping may be used to identify possible copyright infringement. In that example, the scraped web content may be compared to copyrighted material to automatically flag whether the web content may be infringing a copyright holder's rights. In one operation to detect copyright claims, a request may be made of a search engine, which has already gathered a great deal of content on the Internet. The scraped search results may then be compared to a copyrighted work.

In a third example, web scraping may be useful to check placement of paid advertisements on a webpage. For example, many search engines sell keywords, and when a search request includes the sold keyword, they place paid advertisements above unpaid search results on the returned page. Search engines may sell the same keyword to various companies, charging more for preferred placement. In addition, search engines may segment as sales by geographic area. Automated web scraping may be used to determine ad placement for a particular keyword or in a particular geographic area.

In a fourth example, web scraping may be useful to check prices or products listed on e-commerce websites. For example, a company may want to monitor a competitor's prices to guarantee that their prices remain competitive.

To conduct web scraping, the web request may be sent from a proxy server. The proxy server then makes the request on the web scraper's behalf, collects the response from the web server, and forwards the web page data so that the scraper can parse and interpret the page. When the proxy server forwards the requests, it generally does not alter the underlying content, but merely forwards it back to the web scraper. A proxy server changes the request's source IP address, so the web server is not provided with the geographical location of the scraper. Using the proxy server in this way can make the request appear more organic and thus ensure that the results from web scraping represent what would actually be presented were a human to make the request from that geographical location.

Proxy servers fall into various types depending on the IP address used to address a web server. A residential IP address is an address from the range specifically designated by the owning party, usually Internet service providers (ISPs), as assigned to private customers. Usually a residential proxy is an IP address linked to a physical device, for example, a mobile phone or desktop computer. However, businesswise, the blocks of residential IP addresses may be bought from the owning proxy service provider by another company directly, in bulk. Mobile IP proxies are a subset of the residential proxy category. A mobile IP proxy is one with an IP address that is obtained from mobile operators. Mobile IP proxies use mobile data, as opposed to a residential proxy that uses broadband ISPs or home Wi-Fi. A datacenter IP proxy is the proxy server assigned with a datacenter IP. Datacenter IPs are IPs owned by companies, not by individuals. The datacenter proxies are typically IP addresses that are not in a natural person's home.

Exit node proxies, or simply exit nodes, are gateways where the traffic hits the Internet. There can be several proxies used to perform a user's request, but the exit node proxy is the final proxy that contacts the target and forwards the information from the target to a user device, perhaps via a previous proxy. There can be several proxies serving the user's request, forming a proxy chain, passing the request through each proxy, with the exit node being the last link in the chain that ultimately passes the request to the target.

Uniform Resource Locator (URL) redirection, also called URL forwarding, is a World Wide Web technique for making a web page available under more than one URL address. When a web browser attempts to open a URL that has been redirected, a page with a different URL is opened.

Systems and methods are needed for improved web scraping.

### BRIEF SUMMARY

In an embodiment, a computer-implemented method is provided for identifying multiple addresses representing a common web page. In the method, a web scraping request specifying a first address of a target web page to capture content from is received. The target web page is repeatedly scraped. The scraping includes determining whether the first address redirects to a second address of the target web page. The first address is related to the second address in a table mapping requested addresses to redirected addresses. The table is analyzed to generate a plurality of graphs such that each graph has addresses as the nodes of the graph and edges connecting the nodes according to relationships in the table. For respective graphs in the plurality of graphs, an identifier is assigned to addresses in the respective graph such that the identifier indicating that the addresses in the respective graph represent the common web page.

System and computer program product embodiments are also disclosed.

Further embodiments, features, and advantages of the invention, as well as the structure and operation of the various embodiments, are described in detail below with reference to accompanying drawings.

### BRIEF DESCRIPTION OF THE DRAWINGS

The accompanying drawings, which are incorporated herein and form part of the specification, illustrate the present disclosure and, together with the description, further serve to explain the principles of the disclosure and to enable a person skilled in the relevant art to make and use the disclosure.

FIG. 1 is an architecture diagram illustrating a system that allows a client to scrape web content through a proxy.

FIG. 2 illustrates a data flow of a component of the system in FIG. 1.

FIGS. 3-4 illustrate an example of building a graph of redirects to identify multiple addresses representing a common web page.

The drawing in which an element first appears is typically indicated by the leftmost digit or digits in the corresponding reference number. In the drawings, like reference numbers may indicate identical or functionally similar elements.

### DETAILED DESCRIPTION

Embodiments relate to scraping web content. When scraping data, the target website sometimes redirects to different URLs within its domain. The different URLs represent the same context, such as the same social media profile. Embodiments use a graph ontology to identify which redirected URLs represent the same page.

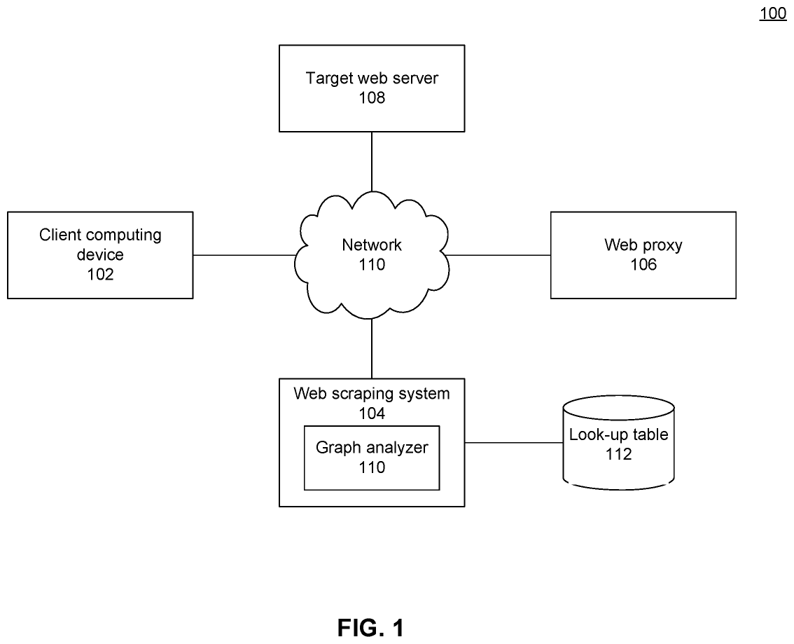

FIG. 1 is an architecture diagram illustrating a system 100 that allows a client to scrape web content through proxy. System 100 includes a client computing device 102, web scraping system 104, a web proxy 106, and a target web server 108. Each of these components include one or more computing devices and are connected through one or more networks 110.

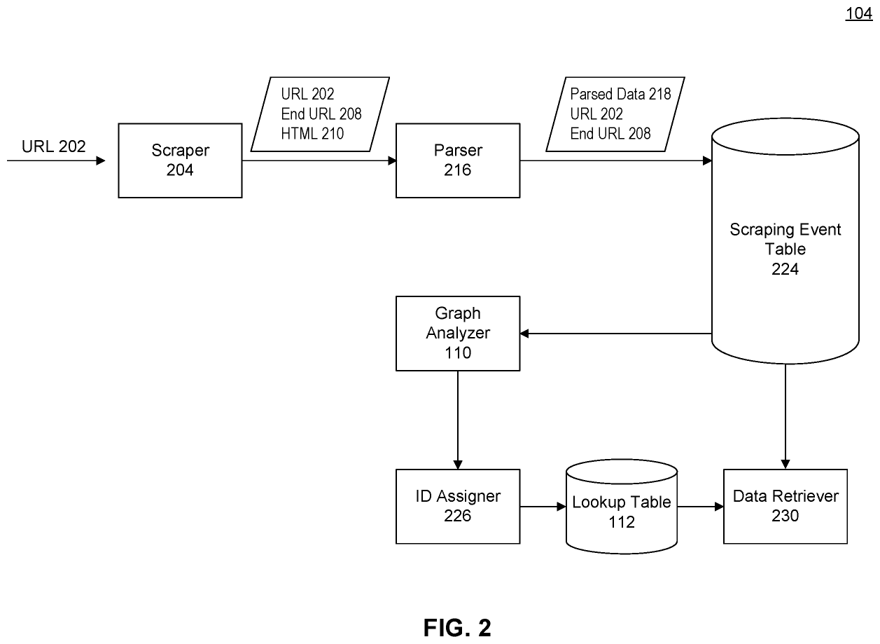

Client computing device 102 is a computing device that initiates requests to scrape content from the web, in particular target web server 108. As described above, client computing device 102 may seek to scrape content for various applications. For example, client computing device 102 may have or interact with software to engage in search engine optimization. Client computing device 102 may be analyzing ad placement or e-commerce products or listed prices. Client computing device 102 sends a request to web scraping system 104. The request can be synchronous or asynchronous and may take a variety of formats as described in more detail with respect to FIG. 2.

Web scraping system 104 develops a request or a sequence of requests that impersonate a human using a web browser. To impersonate non-automated requests to a target website, web scraping system 104 has logic to formulate Hypertext Transfer Protocol (HTTP) requests to the target website. Still further, many of these sites require HTTP cookies from sessions generated previously. An HTTP cookie (usually just called a cookie) is a simple computer data structure made of text written by a web server in previous request-response cycles. The information stored by cookies can be used to personalize the experience when using a website. A website can use cookies to find out if someone has visited a website before and record data about what they did. When someone is using a computer to browse a website, a personalized cookie data structure can be sent from the website's server to the person's computer. The cookie is stored in the web browser on the person's computer. At some time in the future, the person may browse that website again. When the website is found, the person's browser checks whether a cookie for that website is found and available. If a cookie is found, then the data that was stored in the cookie before can be used by the website to tell the website about the person's previous activity. Some examples where cookies are used include shopping carts, automatic login, and remembering which advertisements have already been shown.

Additionally or alternatively, the second request may be generated from other data received in response to the first request, besides cookies. For example, the other data can include other types of headers, parameters, or the body of the response.

Because many websites require session information, usually stored in cookies but possibly received in other data from previously visited retrieved pages, web scraping system 104 may reproduce a series of HTTP requests and responses to scrape data from the target website. For example, to scrape search results, embodiments described herein may first request the page of the general search page where a human user would enter their search terms in a text box on an HTML page. If it were a human user, when the user navigates to that page, the resulting page would likely write a cookie to the user's browser and would present an HTML page with the text box for the user to enter their search terms. Then, the user would enter the search terms in the text box and press a “submit” button on the HTML page presented in a web browser. As a result, the web browser would execute an HTTP POST or GET operation that results in a second HTTP request with the search term and any resulting cookies. According to an embodiment, the system disclosed here would reproduce both HTTP requests, using data, such as cookies, other headers, parameters or data from the body, received in response to the first request to generate the second request.

Once web scraping system 104 formulates an HTTP request, it sends the request to a web proxy 106. Web proxy 106 is a server that acts as an intermediary for requests from clients seeking resources from servers that provide those resources. Web proxy 106 thus functions on behalf of the client when requesting service, potentially masking the true origin of the request to the resource server. Web proxy 106 may receive the request from web scraping system 104 as a proxy protocol request. Examples of a proxy protocol include the HTTP proxy protocol and a SOCKS protocol. Web proxy 106 may include a series of web proxies that transfer data among each other.

Target web server 108 is computer software and underlying hardware that accepts requests and returns responses via HTTP. As input, target web server 108 typically takes the path in the HTTP request, any headers in the HTTP request, and sometimes a body of the HTTP request, and uses that information to generate content to be returned. The content served by the HTTP protocol is often formatted as a webpage, such as using HTML and JavaScript.

The resulting page typically includes HTML. The HTML may include links to other objects, such as images and widgets to display and interact with things like geographic maps (perhaps retrieved from a third party web service). In addition, the HTML may include JavaScript that has some functionality requiring execution to render. In some cases, a client may be interested in aspects of the page not represented in the HTML. In this case, the web scraping system 104 may use a headless web browser that has the necessary functionality to execute the JavaScript and retrieve any objects linked within the HTML. In this way, the headless web browser can develop a full rendering of the scraped webpage, or at least retrieve the information that would be needed to develop the full rendering. Each request is passed through web proxy 106 to target web server 108.

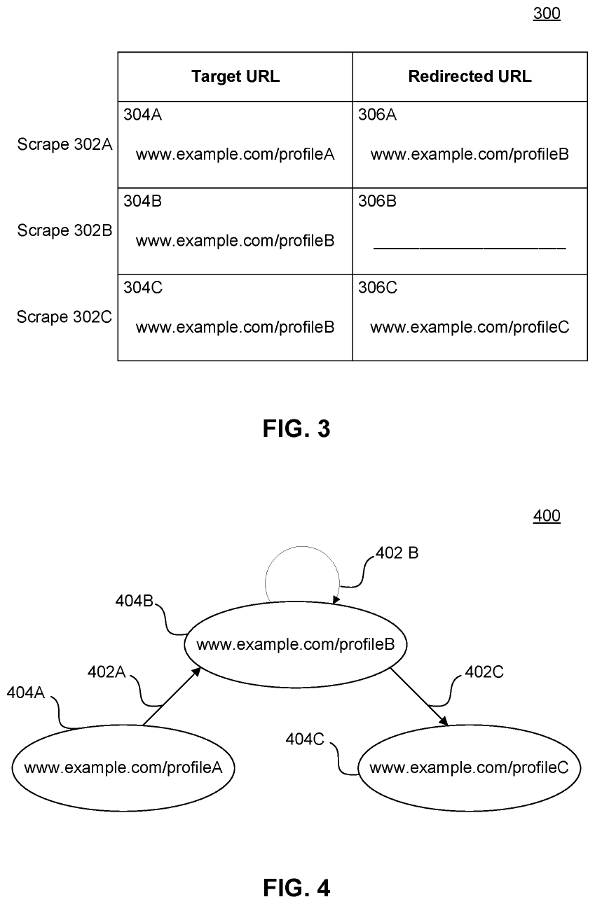

In an embodiment, target Web server 108 may practice URL (uniform resource locator) redirection. URL redirection, also called URL forwarding, is a worldwide web technique for making a webpage available out there more than one URL address. When a web browser, or in this case web scraping system 104, attempts to open a URL that has been redirected, a page with a different URL is opened. To trigger a redirection, target Web server 108 can send several different types of responses. For example, the HTTP protocol used by the World Wide Web implements a redirect using a response with a status code beginning with 3XX. For example, status code 301 indicates a URL has moved permanently, and status code 302 indicates that a URL has been temporarily moved. Other types of redirects are discussed in greater detail below respect to FIGS. 3A-B.

When target Web server 108 returns a redirect, through web proxy 106, to web scraping system 104, web scraping system 104 retrieves the page at the redirected URL. As will be described in greater detail below, web scraping system 104 includes a graph analyzer 110 that constructs a graph based on the redirection. That graph represents a network of URLs that are used to identify a single web page and look-up table 112

FIG. 2 includes a diagram 200 that illustrates an example operation of web scraping system 104 and provides further description of how components of web scraping system while 104 may interact.

Client computing device 102 interacts with web scraping system 104 in various ways. In an embodiment, a client may send in an API request with the parameters describing the web scraping sought to be completed, including a URL 202. In addition, the parameters may include a header information, geolocation information, and browser information, and other values necessary to control the proxy and make the desired request. In this way, web scraping system 104 can synchronously or asynchronously service a client request for the scrape data.

Web scraping system 104 includes a scraper 204 that generates a HTTP requests to target website 108 addressed to URL 202. As described above, web scraping server 104 may not send the requests directly to target website 108 and instead send them through at least one intermediary proxy server 106. To send the request to proxy server 106, a proxy protocol may be used.

To send a request according to an HTTP proxy protocol, the full URL may be passed, instead of just the path. Also, credentials may be required to access the proxy. All the other fields for an HTTP request must also be determined. To reproduce an HTTP request, scraper 204 will generate all the different components of each request, including a method, path, a version of the protocol that the request wants to access, headers, and the body of the request.

An illustrative example of proxy protocol request is reproduced below:
GET https://www.example.com/profileA/HTTP/1.1
Proxy-Authorization: Basic encoded-credentials
Accept: text/html
User-Agent: Mozilla/5.0
Cookie: Location=Alexandria, VA, USA;

In the above example, the HTTP method invoked is a GET command, and the version of the protocol is “HTTP/1.1.” The path is “https://www.example.com/profileA/,” and because it includes a full URL as opposed to URI, it may signify to web proxy 106 that the HTTP request is for a proxy request. The body of the request is empty.

The example HTTP proxy protocol request above includes four headers: “Proxy-Authorization,” “Accept,” “User-Agent,” and “Cookie.” The “Proxy-Authorization” header provides authorization credentials for connecting to a proxy. The “Accept” header provides media type(s) that is/are acceptable for the response. The “User Agent” header provides a user agent string identifying the user agent. For example, the “User Agent” header may identify the type of browser and whether or not the browser is a mobile or desktop browser. The “Cookie” header is an HTTP cookie previously sent by the server with Set-Cookie (below). In this case, the server may be set up to previously have saved the location of the user. Thus, if the user had previously visited the server from Alexandria, Virginia, the server would, for example, save “Alexandria, VA, USA” as a cookie value. By sending such a cookie value with the request, web scraping system 104 can simulate the geolocation without having previously visited the location and without needing a proxy IP address located in Alexandria, Virginia. Scraper 204 may profile these values to resemble requests that would be plausibly generated by a browser controlled by a human. In this way, web scraping system 104 may generate the HTTP requests to avoid the target web server being able to detect that the requests are automatically generated from a bot.

In response, target website 108 (which, in the example above, has the hostname www.example.com) will return an HTTP response with the website located at its path “/profileA”. As mentioned above, target website 108 may respond with an instruction to redirect. The redirect may be implemented in various ways, including using HTTP or using an instruction in the page itself, for example, in HTML or JavaScript. Various examples of redirects are set out below.

In a first example, as described above, an HTTP 3XX code may be used. In that example, target website 108 response to the HTTP request with HTTP response having such a code and the redirected URL. An example to redirect to “www.example.com/profileB” is set out below:
HTTP/1.1 301 Moved Permanently
Location: https://www.example.com/profile B

In a second example, the redirect may be implemented using a “Refresh” header in the HTTP response. An example is below:
HTTP/1.1 200 OK
Refresh: 0; url=http://www.example.com/profileB
Content-Type: text/html

In a third example, the redirect may be implemented using a meta-tag in the HTML file returned from target website 108. Example HTML is set out below:
<html>
<head>
   <meta http-equiv=“Refresh” content=“0; url=http://www.example.com/profileB”/>
</head>
</html>

In a third example, the redirect may be implemented using JavaScript by setting the window.location attribute. Example JavaScript returned from target server 108 may include the commands “window.location=‘http://www.example.com/profileB’” or “window.location.replace (′http://www.example.com/profileB′)”

In a fourth example, the redirect may be implemented using HTML frames. Example HTML is below:
<iframe height=“100%” width=“100%” src=“http://www.example.com/profileB”>
   </iframe>

In a fifth example, the link may be extracted from some other tag, such as a link tag, in the HTML to recognize that a redirect is occurring. Example HTML is below:
<link rel=“canonical” href=“https://www.example.com/in/john-doe-123456”>

In some embodiments, scraper 204 may encounter multiple redirects before finally reaches the end URL.

Regardless, scraper 204 captures the HTML of the end URL and transfers the starting, requested URL 202, end URL 208 (the final URL after redirects of the scraped page), and HTML 210 of the scraped page to a parser 216. In the example above, the requested URL 202 is “http://www.example.com/profileA” and the end URL 208 is “http://www.example.com/profileB”.

Parser 216 may analyze the scraped HTML file and may extract relevant fields from the HTML file. To analyze the HTML file, parser 216 may use a known format or patterns within the HTML file (such as the Document Object Model) to identify where the relevant fields are located. With the relevant fields extracted, parser 216 may insert the extracted fields into a new data structure, such as a file. In an example, the new file may be a JavaScript Object Notation (JSON) format, which is a standard data interchange format. The resulting file with the parsed data may be stored in a scraping event table 224, along with URL 202 and end URL 208.

Scraping event table 224 may be an archival, or cold database service. History archive 306 stores the scraped data for longer than job database 314. It is not meant to represent current content from a target website, instead representing historical content. In the event that a client makes an identical request twice, the results may only be stored in scraping event table 224 if the results from the first request are older than a certain age, such as one month. In one embodiment, scraping event table 224 may store parsed scraped data but not HTML, data because HTML, data has structure and formatting that may not be relevant to a client. When the parsed data is stored, a job description may be also stored and used as metadata in an index to allow the parsed data to be searched. The metadata stored with the parsed data includes URL 202 and end URL 208.

An example of URLs and end URLs in scraping event table 224 are illustrated in table 300. Table 300 includes three rows-302A, 302B, and 302C—each representing a scraping event. Each row has a target URL and a redirected, or end URL. Row 302A represents the example scraping requests described above as a target URL 304A “www.example.com/profileA” and an end URL 306A “www.example.com/profileB”. Rows 302B and 302C may represent subsequent scraping events. With row 302B, the target URL was “www.example.com/profileB” and no redirection occurred, so a null value is stored as redirected URL 306B. With row 302C, the target URL was “www.example.com/profileB” and the request is redirected to “www.example.com/profileC.”

Turning to FIG. 2, graph analyzer 110 analyzes data from scraping event table 224. This operation can be done periodically on a batch basis. Graph analyzer 110 analyzes scraping event table 224 to generate graphs representing the network of redirected URLs. Each graph has addresses as the nodes of the graph and edges connecting the nodes according to relationships in the table. Each graph may, in an embodiment, be limited to URLs having a common hostname (e.g., “www.example.com”), but different paths (e.g., “/profileA”, “/profileB”, “/profileC”). In one example, the various URLs may address a single social media profile. An example graph is illustrated in FIG. 4.

FIG. 4 illustrates an example of building a graph 400 of redirects to identify multiple addresses representing a common web page. Graph 400 may be constructed to represent the scraping events in FIG. 3. For each of the three URLs—“www.example.com/profileA,” “www.example.com/profileB,” and “www.example.com/profileC”—are represented by a respective node—node 404A, node 404B, and 404C. The nodes are connected by edges 402A, 402B, and 402C, each representing a scraping event. Because at the scraping event represented by row 302A, URL “www.example.com/profileA” (represented by node 404A) is redirected to URL “www.example.com/profileB” (represented by node 404B), edge 402A connects to node 404A to node 404B. Optionally, because at the scraping event represented by row 302B, URL “www.example.com/profileB” (represented by node 404B) does not redirect anywhere, edge 402B connects to node 404B to itself. Because at the scraping event represented by row 302C, URL “www.example.com/profileB” (represented by node 404B) is redirected to URL “www.example.com/profileC” (represented by node 404C), edge 402C connects to node 404B to node 404C.

Returning to FIG. 2, once graph analyzer 110 constructs the graphs, ID assigner 226 assigns an identifier to respective graphs in the plurality of graphs. The identifier indicates that the addresses in the respective graph represent a common web page. For example, a single ID may be assigned to the graph in FIG. 4. Graph analyzer 110 then stores the ID mapped to identifiers for the respective scraping events represented by the graph FIG. 4 (as illustrated in FIG. 3) into lookup table 112.

Data retriever 230 uses lookup table 112 to identify all the scraping events for a common web page. To do that, data retriever 230 identifies a graph ID associated with a requested URL from lookup table 112. The graph ID is assigned to all the URLs associated with that common page in lookup table 112. Then, data retriever 230 retrieves all the scraping events (and corresponding parsed data) for all the URLs associated with the graph ID.

Each of the modules, servers and other components described above (including client computing device 102, web scraping system 104, web proxy 106, target web server 108, scraper 204, parser 216, graph analyzer 110, ID assigner 226, and data retriever 230 may be implemented on software executed on one or more computing devices or different computing devices.

A computing device may include one or more processors (also called central processing units, or CPUs). The processor may be connected to a communication infrastructure or bus. The computer device may also include user input/output device(s), such as monitors, keyboards, pointing devices, etc., which may communicate with communication infrastructure through user input/output interface(s).

One or more of the processors may be a graphics processing units (GPU). In an embodiment, a GPU may be a processor that is a specialized electronic circuit designed to process mathematically intensive applications. The GPU may have a parallel structure that is efficient for parallel processing of large blocks of data, such as mathematically intensive data common to computer graphics applications, images, videos, etc.

The computer device may also include a main or primary memory 408, such as random access memory (RAM). Main memory 408 may include one or more levels of cache. Main memory 408 may have stored therein control logic (i.e., computer software) and/or data.

The computer device may also include one or more secondary storage devices or memory. The secondary memory may include, for example, a hard disk drive, flash storage and/or a removable storage device or drive.

The computing device may further include a communication or network interface. The communication interface may allow the computer system 400 to communicate and interact with any combination of external devices, external networks, external entities, etc. For example, the communication interface may allow the computer system to access external devices via network 110, which may be wired and/or wireless (or a combination thereof), and which may include any combination of LANs, WANs, the Internet, etc

The computing device may also be any of a rack computer, server blade, personal digital assistant (PDA), desktop workstation, laptop or notebook computer, netbook, tablet, smartphone, smartwatch or other wearable, appliance, part of the Internet-of-Things, and/or embedded system, to name a few non-limiting examples, or any combination thereof.

The computer device may access or host any applications and/or data through any delivery paradigm, including but not limited to remote or distributed cloud computing solutions; local or on-premises software (“on-premise” cloud-based solutions); “as a service” models (e.g., content as a service (CaaS), digital content as a service (DCaaS), software as a service (SaaS), managed software as a service (MSaaS), platform as a service (PaaS), desktop as a service (DaaS), framework as a service (FaaS), backend as a service (BaaS), mobile backend as a service (MBaaS), infrastructure as a service (IaaS), etc.); and/or a hybrid model including any combination of the foregoing examples or other services or delivery paradigms.

Any applicable data structures, file formats, and schemas in the computing devices may be derived from standards including but not limited to JavaScript Object Notation (JSON), Extensible Markup Language (XML), Yet Another Markup Language (YAML), Extensible Hypertext Markup Language (XHTML), Wireless Markup Language (WML), MessagePack, XML User Interface Language (XUL), or any other functionally similar representations alone or in combination. Alternatively, proprietary data structures, formats or schemas may be used, either exclusively or in combination with known or open standards. Any of the databases or files described above (including scraping event table 224 and lookup table 112) may be stored in any format, structure, or schema in any type of memory and in a computing device.

In some embodiments, a tangible, non-transitory apparatus or article of manufacture comprising a tangible, non-transitory computer-usable or readable medium having control logic (software) stored thereon may also be referred to herein as a computer program product or program storage device. This includes, but is not limited to, main memory, secondary memory, and removable storage units, as well as tangible articles of manufacture embodying any combination of the foregoing. Such control logic may cause such data processing devices to operate as described herein.

A website is a collection of web pages containing related contents identified by a common domain name and published on at least one web server. A domain name is a series of alphanumeric strings separated by periods, serving as an address for a computer network connection and identifying the owner of the address. Domain names consist of two main elements—the website's name and the domain extension (e.g., .com). Typically, websites are dedicated to a particular type of content or service. A website can contain hyperlinks to several web pages, enabling a visitor to navigate between web pages. Web pages are documents containing specific collections of resources that are displayed in a web browser. A web page's fundamental element is one or more text files written in Hypertext Markup Language (HTML). Each web page in a website is identified by a distinct URL (Uniform Resource Locator). There are many varieties of websites, each providing a particular type of content or service.

Identifiers, such as “(a),” “(b),” “(i),” “(ii),” etc., are sometimes used for different elements or steps. These identifiers are used for clarity and do not necessarily designate an order for the elements or steps.

The present invention has been described above with the aid of functional building blocks illustrating the implementation of specified functions and relationships thereof. The boundaries of these functional building blocks have been arbitrarily defined herein for the convenience of the description. Alternate boundaries can be defined so long as the specified functions and relationships thereof are appropriately performed.

The foregoing description of the specific embodiments will so fully reveal the general nature of the invention that others can, by applying knowledge within the skill of the art, readily modify and/or adapt for various applications such as specific embodiments, without undue experimentation, and without departing from the general concept of the present invention. Therefore, such adaptations and modifications are intended to be within the meaning and range of equivalents of the disclosed embodiments based on the teaching and guidance presented herein. It is to be understood that the phraseology or terminology herein is for the purpose of description and not of limitation, such that the terminology or phraseology of the present specification is to be interpreted by the skilled artisan in light of the teachings and guidance.

The breadth and scope of the present invention should not be limited by any of the above-described exemplary embodiments, but should be defined only in accordance with the following claims and their equivalents,

A having instructions stored thereon are disclosed that, when executed by at least one computing device, causes the at least one computing device to perform operations for identifying multiple addresses representing a common web page, the operations comprising:
(a) receiving a web scraping request specifying a first address of a target web page to capture content from;
(b) repeatedly scraping the target web page, wherein the scraping comprises determining whether the first address redirects to a second address of the target web page;
(c) relating the first address to the second address in a table mapping requested addresses to redirected addresses;
(d) analyzing the table to generate a plurality of graphs, each graph having addresses as the nodes of the graph and edges connecting the nodes according to relationships in the table; and
(e) for respective graphs in the plurality of graphs, assigning an identifier to addresses in the respective graph, the identifier indicating that the addresses in the respective graph represent the common web page.

Any method or non-transitory computer-readable device above is disclosed wherein the first and second addresses are Uniform Resource Locators.

Any method or non-transitory computer-readable device above is disclosed where the first and second addresses address different paths at a common hostname.

Any method or non-transitory computer-readable device above is disclosed wherein the target web page is a social media profile.

Any method or non-transitory computer-readable device above is disclosed wherein first address redirects to the second address using an HTTP redirect.

Any method or non-transitory computer-readable device above is disclosed wherein the first address redirects to the second address using a reference in an HTML page.

Any method or non-transitory computer-readable device above is disclosed the operations further comprising determining, based on the identifier, that the addresses are duplicative.

Any method or non-transitory computer-readable device above is disclosed further comprising retrieving, based on the identifier, scraped data retrieved from addresses.

Any method or non-transitory computer-readable device above is disclosed wherein the scraping occurs through a proxy server.

Any method or non-transitory computer-readable device above is disclosed further comprising using the identifier to retrieve scraped data from the multiple addresses representing the common web page.

1. A computer-implemented method for identifying multiple addresses representing a common web page, comprising:
(a) receiving a web scraping request specifying a first address of a target a page to capture content from;
(b) repeatedly scraping the target web page, wherein the scraping comprises determining whether the first address redirects to a second address of the target web page and wherein the scraping occurs through a proxy server;
(c) relating the first address to the second address in a scraping event table mapping requested addresses to redirected addresses;
(d) analyzing the scraping event table to generate a plurality of graphs, each graph having addresses as the nodes of the graph and edges connecting the nodes according to relationships in the scraping event table;
(e) fora respective graph in the plurality of graphs, assigning an identifier to addresses in the respective graph, the identifier indicating that the addresses in the respective graph represent the common web page; and
(f) retrieving, using the identifier, scraped data and corresponding parsed data from multiple addresses representing the common web page from the scraping event table.

2. The method of claim 1, wherein the first and second addresses are Uniform Resource Locators.

3. The method of claim 1, wherein the first and second addresses address different paths at a common hostname.

4. The method of claim 1, wherein the target web page is a social media profile.

5. The method of claim 1, wherein the first address redirects to the second address using an HTTP redirect.

6. The method of claim 1, wherein the first address redirects to the second address using a reference in an HTML page.

7. The method of claim 1, further comprising determining, based on the identifier, that the addresses are duplicative.

8. The method of claim 1, further comprising retrieving, based on the identifier, scraped data retrieved from addresses.

9. (canceled)

10. The method of claim 1, wherein the retrieving further comprises:
receiving a requested uniform resource locator (URL); and
selecting an identifier associated with the requested URL from a lookup table.

11. A non-transitory computer-readable device having instructions stored thereon that, when executed by at least one computing device, causes the at least one computing device to perform operations for identifying multiple addresses representing a common web page, the operations comprising:
(a) receiving a web scraping request specifying a first address of a target web page to capture content from;
(b) repeatedly scraping the target web page, wherein the scraping comprises determining whether the first address redirects to a second address of the target web page and wherein the scraping occurs through a proxy server;
(c) relating the first address to the second address in a scraping event table mapping requested addresses to redirected addresses;
(d) analyzing the scraping event table to generate a plurality of graphs, each graph having addresses as the nodes of the graph and edges connecting the nodes according to relationships in the scraping event table;
(e) fora respective graph in the plurality of graphs, assigning an identifier to addresses in the respective graph, the identifier indicating that the addresses in the respective graph represent the common web page; and
(f) retrieving, using the identifier, scraped data and corresponding parsed data from multiple addresses representing the common web page from the scraping event table.

12. The computer-readable device of claim 11, wherein the first and second addresses are Uniform Resource Locators.

13. The computer-readable device of claim 11, wherein the first and second addresses address different paths at a common hostname.

14. The computer-readable device of claim 11, wherein the target web page is a social media profile.

15. The computer-readable device of claim 11, wherein the first address redirects to the second address using an HTTP redirect.

16. The computer-readable device of claim 11, wherein the first address redirects to the second address using a reference in an HTML page.

17. The computer-readable device of claim 11, further comprising determining, based on the identifier, that the addresses are duplicative.

18. The computer-readable device of claim 11, further comprising retrieving, based on the identifier, scraped data retrieved from addresses.

19. (canceled)

20. The computer-readable device of claim 11, wherein the retrieving further comprises:
receiving a requested uniform resource locator (URL), and
selecting an identifier associated with the requested URL from a lookup table.
